(19) United States
(12) Patent Application Publication
(10) Pub. No.: US 2004/0076346 A1
(43) Pub. Date: Apr. 22, 2004

(54) Imaging system and method

(76) Inventor: Virgil Kay Russon, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/273,708

(22) Filed: Oct. 18, 2002

(51) Int. Cl. G06F 3/05; G06T 3/40; H04N 1/393

(52) U.S. Cl. 382/318; 382/298; 358/451

(57) ABSTRACT

A method of displaying a scanned image, comprising the steps: optically scanning a document to render an electronic image of the document, zooming in on the image to magnify a subset of the electronic image using a software zooming methodology, thereby rendering a first zoomed image; and refreshing the first zoomed image by optically scanning a subset of the document corresponding to the first zoomed image.

### BACKGROUND

The present invention generally relates to imaging, and more particularly to an improved system and method for imaging.

Optical scanners are commonly-used in a variety of settings to convert an image, text, or other information into data. The data can be stored in a computer file and/or used to render the scanned image, text, or other information onto a computer monitor. Various technologies exist and are known for scanning documents into data, and a wide variety of commercial and consumer scanners are available in the market.

Optical scanners are typically connected to and controlled by a computer running application-specific imaging software. A common feature included with many imaging software packages is the ability to zoom in and out on a scanned image. That is, after the image has been initially scanned and rendered on a computer monitor, a user may selectively narrow the area of interest and magnify, or “zoom in” on, a selected portion of a scanned image. Further, after an image has been magnified, the user may selectively expand the area of interest and de-magnify, or “zoom out” on, the image. The user may zoom in on a selected portion of the scanned image several times, thereby creating several “zoom levels”, to highly magnify a portion of the image. The degree to which a user can zoom out is limited to the size of the original scanned image.

At least two common techniques are known for zooming in and out on scanned images. The first technique, known as “hardware zooming”, involves physically re-scanning a selected subset of the document each time a “zoom in” is requested. Specifically, each time the user requests a “zoom in” or “zoom out”, the movable scanning mechanism inside of the scanner must be activated and the selected portion of the document must be re-scanned. Each “zoom in” or “zoom out” image produced by the “hardware zooming” technique results in a relatively clear scanned image because each “zoom” image is directly rendered from a fresh set of data derived from a new scan. However, using the “hardware zooming” method, the speed in which a zoomed image can be rendered to the computer monitor is limited by the speed of the optical scanning process. Accordingly, re-scanning the document each time a “zoom” function is requested causes a significant delay between the time that the “zoom” function is requested by the user and the time that the zoomed image is displayed on the computer monitor.

A second zooming technique, known as “software zooming”, involves storing the image data from the original scan in the computer and using various software algorithms to scale that data each time a zoom function is requested. The data is scaled up to “zoom in” and scaled down to “zoom out.” Because software zooming is performed without physically re-scanning the original document, it is performed very quickly, resulting in little or no delay between the time a zoom function is requested and the time the re-rendered image appears on the computer monitor. However, “software zooming” results in a loss of clarity and detail of the zoomed image. Thus, each time a user zooms in on a portion of the original scanned image, the zoomed image becomes less and less clear.

In known systems that employ a software zooming technique, the phenomena of the zoomed image becoming less and less clear each time the image is zoom in upon is unavoidable. Further, in known systems that employ a hardware zooming technique, it is not possible to decrease the elapsed time required for a zoom function, by using a software zooming technique or otherwise.

### SUMMARY

In the representative embodiments, the present invention relates to a method of displaying a scanned image, comprising the steps: (i) optically scanning a document to render an electronic image of the document, (ii) zooming in on the image to magnify a subset of the electronic image using a software zooming methodology, thereby rendering a first zoomed image; and (iii) refreshing the first zoomed image by optically scanning a subset of the document corresponding to the first zoomed image.

### BRIEF DESCRIPTION OF THE DRAWINGS

Other aspects and advantages of the invention will become apparent from the following detailed description, taken in conjunction with the accompanying drawings, illustrating by way of example the principles of the invention.

FIG. 1 generally illustrates an arrangement of hardware used for scanning a document to create a set of data used to render an electronic image of the document.

FIG. 2 is a logical diagram illustrating a representative embodiment of the invention.

FIG. 3 is a flowchart setting forth exemplary steps taken by a controller in implementing a representative embodiment of the invention.

### DETAILED DESCRIPTION

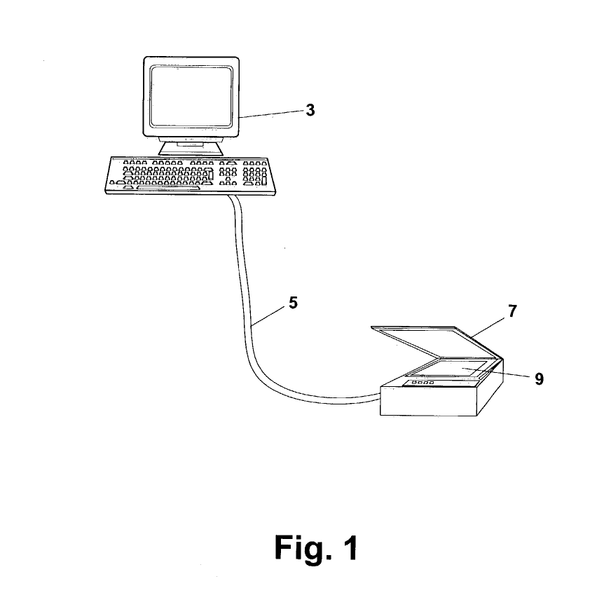

FIG. 1 is a diagram of an arrangement of hardware components for scanning documents, though other arrangements can be used in connection with the invention as described herein. A scanner 7 is typically connected to a computer 3 by a communication cable 5. The scanner 7 generally has a flat glass bed, referred to as a “platen” by those skilled in the art, upon which document 9 lies face-down during the scanning process. Sometimes, however, the platen is on an angle, and sometimes it is even on edge. To scan the document, a movable optical scanning apparatus moves below the platen to detect the markings on the document 9 that comprise the visible image. The scanner 7 converts the detected markings into data that represent the image on the document. The data is transmitted to the computer 3 over communication cable 5. The computer 3 includes an internal processor or “microcontroller” (not shown) that controls the operation and communications of the computer 3 in response to a series of computer-readable instructions. Typically, the computer 3 interprets the data and renders an electronic image on the computer monitor that reflects the image scanned from the original document. While a general description of a document scanning arrangement has been described, one skilled in the art will recognize that various such arrangements and a variety of different types of scanners can be used in connection with the present invention.

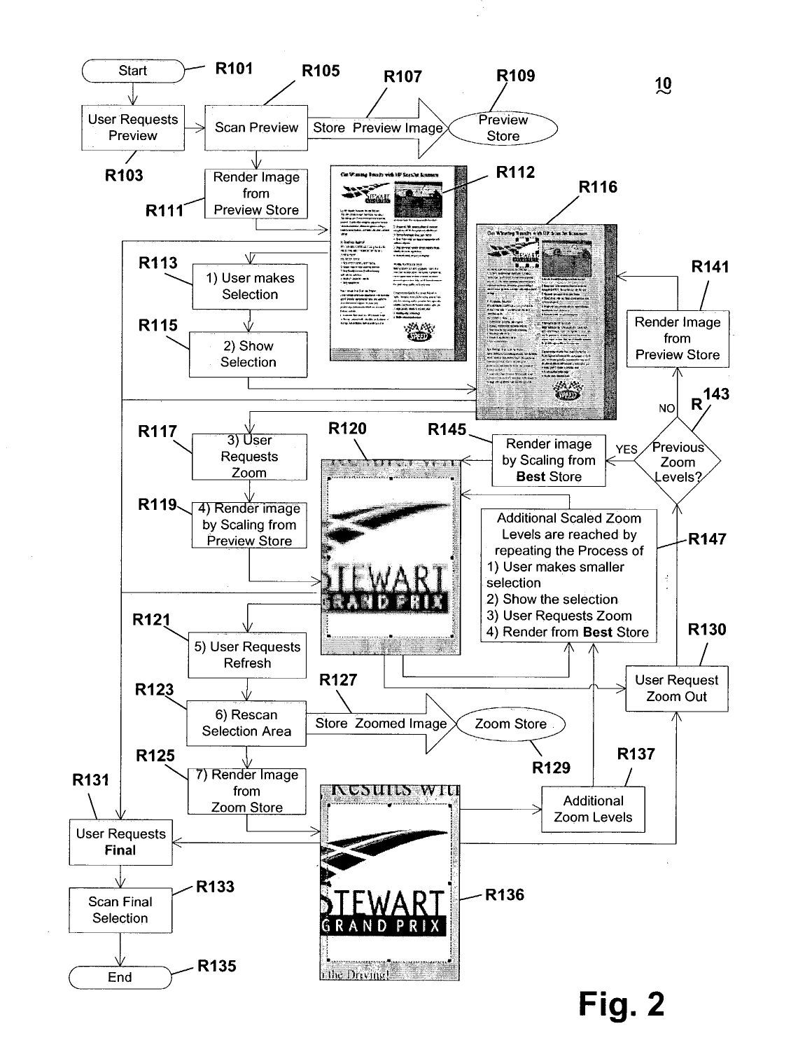

FIG. 2 is a logical block diagram of an embodiment of a process 10 of the present invention. In sum, the described embodiment of the invention allows a user to selectively “zoom in” and “zoom out” on an image rendered on the computer monitor (derived from an optical scanner) using a software zoom technique. At the user's request—typically when the image on the computer monitor has been zoomed in to such a degree that the clarity of the image is no longer adequate—the zoomed image can be “refreshed” by performing a re-scan of just the zoomed image. In this way, a new set of data is obtained, which corresponds just to the selected portion of the entire image, i.e., the “zoomed image.” As a result, the clarity of the zoomed image is restored to the same clarity as the image derived from the original scan. This process of “zooming in” and periodically “refreshing” can be repeated at the discretion of the user. Further, the user may selectively “zoom out” on the image to the level of the original scan.

Now, referring to FIG. 2 in more detail, the process begins at reference numeral R101. At R103, a user requests that a document scan be initiated. This request can be made through a menu selection in a scanning application software package or other conventional means. After receiving the request, computer 3 causes scanner 7 at R105 to begin a “preview scan” of document 9 on the platen. The general purpose of the preview scan is to obtain a relatively rough rendering of the image on the computer monitor in a relatively short amount of time. The rough image derived from the “preview scan” allows the user to perform various activities, such as selecting all or a portion of the image for a “final scan” or zooming in on a subset of the document and ultimately selecting a portion of the document for a “final scan.” To this end, the preview scan is preferably performed at a relatively low resolution level, such as approximately 37 to 75 dots per inch (DPI). This low resolution level enables the scanner 7 to physically scan the document more quickly than if a higher resolution were used, while, at the same time, provides sufficient detail in the rendered image to enable the user to see the image on the computer monitor and select a portion of the image to zoom in upon. The data derived from the preview scan is transmitted to the computer 3 over communication line 5, and is stored in computer 3 at R107. The stored data, referred to as the “Preview Store” file R109, is preferably stored in a segment of the computer's random access memory (RAM), though it can also be stored on various types of memory devices or on magnetic or optical media storage devices, including hard drives.

At R111 the computer interprets the stored data and renders an image R112 on the computer monitor therefrom. At this point, the user has two choices. First, at R131, the user can issue a command that the scanner perform a “final scan” of the entire document. A “final scan” is one in which a selected portion of the document is scanned at a desired resolution appropriate for the intended use of the scanned image, which is typically greater than the “preview scan” resolution. For example, the final scan is commonly performed at 75, 150, 300, 600, 1200, or greater DPI, depending on the circumstances. Because of the higher resolution of the scan, the time required for the final scan is longer than that required for the preview scan. At R133, the scanner optically scans the entire document, thereby converting the image on the document into data. At R135, the process is ended. The data derived from the final scan can be used in a variety of ways, including to render the image on the computer monitor or to print the image on an attached printer or plotter. Further, the data can be saved in a computer file for later access.

Instead of choosing to perform a “final scan”, the user may elect to zoom in on a selected portion of the image on the computer monitor. If so, at R113, the user identifies a portion of the image to zoom in on. One way of performing this function is for the user to use the computer mouse to draw a “selection box” around a particular subset of the image on the computer monitor, though various other methods may be used. At block R115, the user's selection is shown on the computer monitor, as illustrated at R116. Once the selection is made, the user issues a command for the computer to “zoom in” at block R117, and the computer renders a magnified version of the selected portion of the image, as illustrated at R120. The zoom function is performed using a “software zoom”, according to various known methods of performing “software zooms.” In general terms, as indicated above, the computer uses various software algorithms and routines to scale the data stored in the preview store R109 corresponding to the selected zoom area of the full image. As shown at R120, the process of scaling the data results in a magnified image having less resolution and detail than the original scanned preview image.

After the software zoom R119 has been performed, the user can follow several different paths. First, the user may issue a “final scan” command to the computer, whereby the scanner scans the zoomed portion of the original document at a final (normally higher) resolution. If the user elects to perform a “final scan”, steps R131, R133, and R135 are performed, as described above.

Second, the user may elect to further zoom in on the image using the software zooming technique. In this case, the user may continue to zoom in on smaller and smaller subsets of the entire scanned image by repeating steps R113, R115, R117, and R119, as described above and illustrated at R147. Specifically, the user would select another smaller subset of the scanned image and issue a “zoom in” command to the computer. The computer would render a further magnified version of the newly-selected subset of the scanned image. Each time the user further “zooms in” on the scanned image using the “software zoom” technique, it is said to be a new “zoom level.” For example, the first “zoom in” function performed on the scanned image results in a “zoom level 1”; and a subsequent “zoom in” function results in a “zoom level 2.” The higher the zoom level (i.e., the higher the magnification), the more the clarity of the image displayed on the computer monitor is degraded, until, at some point, the zoomed image becomes virtually unreadable.

Because the “software zoom” technique degrades the clarity of the zoomed image, the user may find it desirable to “refresh” the zoomed image to improve its clarity. According to this particular embodiment of the present invention, the user may refresh the zoomed image by issuing a command to the computer that causes the scanner to re-scan the selected area of the original document corresponding to the zoomed image. More specifically, the user issues a command to the computer indicating a desire to “refresh” the zoomed image at R121. At R123, the computer communicates with the scanner to cause the scanner to optically re-scan the portion of the original document corresponding to the zoomed image on the computer monitor. “Refresh” scans are preferably performed using approximately the same resolution as the original “preview” scan to ensure a relatively fast scan time. In any event, the “refresh” scan is performed in such a way that the “refresh” scan time is faster than the time required for a “final scan”, which can usually be accomplished by performing the “refresh” scan at a lower resolution than that of a “final scan.” The data associated with the re-scan (corresponding to the zoomed image on the computer monitor) is stored by the computer in a “zoom store” (see blocks R127 and R129), which can comprise a segment of any suitable computer memory or data storage device. Finally, at R125, the computer renders a new version of the zoomed image directly from the data stored in the “zoom store.” Typically, the re-scan may contain the same number of pixels as the preview scan, but over a small area of the entire document on the scanner, and at a higher scan resolution. As a result, the zoomed image appears much clearer on the computer monitor than that rendered from scaling the data from the preview store (R109), as shown at R136. As described in more detail hereinafter, the process of selectively “zooming in” on an image and periodically “refreshing” the image can be repeated at the discretion of the user. The set of data derived from each re-scan is preferably stored in its own “zoom store” and used to render images on the computer monitor. Hereinafter, each set of data derived from a re-scan (and stored in a “zoom store”) is referred to as a distinct “re-scan level.” For example, the first time that a zoomed image is refreshed, the stored data is referred to as “re-scan level 1”; and the second time that a zoomed image (at a higher magnification level) is refreshed, the stored data is referred to as “re-scan level 2”, etc.

Once the zoomed image has been refreshed (see, R136), the user has several options. First, the user could elect to conduct a “final scan”, which would be carried out in the same fashion as described above in steps R131, R133, and R135. Second, the user could elect to further zoom in on the zoomed image. In this second situation, the user would issue a “zoom in” command to the computer at R137 that would initiate the steps of the process described above for performing a “zoom in” function (using the software zoom technique), described at R147, R113, R115, R117 and R119. More specifically, the user would select a subset of the zoomed image on the computer monitor, and the computer would scale the data associated with the selected subset of the zoomed image to render a higher zoom level (higher magnification). However, instead of scaling the data from the “preview store” (which stores the data corresponding to the original preview scan of the document), the new zoomed image would be rendered, at R137, by scaling the data from the “zoom store.” By scaling the data in the “zoom store” (which represents a higher resolution depiction of the zoomed image) instead of the “preview store”, the newly-zoomed image displayed on the computer monitor will show a relatively higher level of detail. Again, the user may elect to continue zooming in on the image, each time rendering a magnified subset of the entire image from the “zoom store” data. Zoomed images are preferably rendered from the “best re-scan store”, that holds the data associated with the highest “re-scan level” sufficient to render the desired zoom level.

Finally, in addition to zooming in, this embodiment of the invention allows users to “zoom out” to previous zoom levels to and including the original preview scan level. That is, once the user has zoomed in on a particular subset of the entire document, the user can also zoom out to encompass more of the original document in the image displayed on the computer monitor. Referring to FIG. 2, the user can elect to “zoom out” from either R120 or R136. That is, the user can zoom out either from an image on the computer monitor that has been rendered by scaling the data from the “preview store” or a “zoom store” (e.g., R120) or from an image on the computer monitor that has been rendered from a “zoom store” immediately after a “refresh” has occurred (e.g., R136). In either situation, the user initiates a “zoom out” function by issuing a command to the computer to “zoom out” at R139. Then, at R143, it is determined whether there has been one or more previous “refresh” functions performed and, therefore, one or more re-scan levels stored. If so, then the computer renders a “zoom out” image on the computer monitor at R145 by scaling the data from the “best zoom store.” If no previous “refresh” functions had been performed, then the computer, at R141, renders a “zoom out” image on the computer monitor from the data stored in the “preview store” derived from the original scan of the document.

The user may selectively “zoom in”, “refresh”, and “zoom out” many times. Each zoom function is performed quickly with little or no delay between the zoom request and the rendering of the zoomed image on the computer monitor. Each time an image is “refreshed”, the quality of the current zoomed image, as well as subsequent zoomed images, is improved, though at the cost of a time-delay.

For purposes of illustration only, the following example demonstrates some of the functionality of the above-described embodiment of the invention, with reference to FIG. 2. Assume a user, having placed a document on the scanner bed, initiates a “scan” command at block R103. The scanner conducts a “preview scan” at R105. The computer stores the data derived from the preview scan in a “preview store” at R107 and R109, and the computer renders the image on the computer monitor from the data contained in the preview store. Assume that the user zooms in on the image four times, each time selecting and magnifying a more narrow subset of the full image, thereby resulting in a zoom level 4 image displayed on the computer monitor (see, R147, R113, R115, R117, R119). Further assume that the user had “refreshed” the zoomed image twice, once at zoom level 2 and once at zoom level 4, thereby creating “re-scan level 1” (corresponding to zoom level 2) and “re-scan level 2” (corresponding to zoom level 4). The data associated with re-scan level 1 and the data associated with re-scan level 2 are stored in respective “zoom stores” for access during “zoom in” and “zoom out” functions. The zoom level 4 image currently displayed on the computer monitor is relatively clear because it is rendered from the data in re-scan level 2. If the user now issues a “zoom out” command, the image on the computer screen would be de-magnified to zoom level 3. The zoom level 3 image would be rendered by scaling the data stored in the “zoom store” corresponding to re-scan level 1, which is preferably the “best re-scan store” (the area covered by the data in re-scan level 2 would be insufficient to generate the image of zoom level 3). If the user issues another “zoom out” command, the image on the computer screen would be de-magnified to zoom level 2. Because zoom level 2 had been previously “refreshed”, the zoom level 2 image would be rendered directly from the data stored in the “zoom store” corresponding to re-scan level 1 without the need to scale the data. If the user issued yet another “zoom out” command, the image on the computer screen would be de-magnified to zoom level 1. Because there is no “re-scan level” associated with zoom level 1, the zoom level 1 image would be scaled from the data associated with the “preview scan”, which is stored in the “preview store.” Finally, if the user issued a final “zoom out” command, the image on the computer screen would be de-magnified to the original image rendered directly from the “preview scan.”

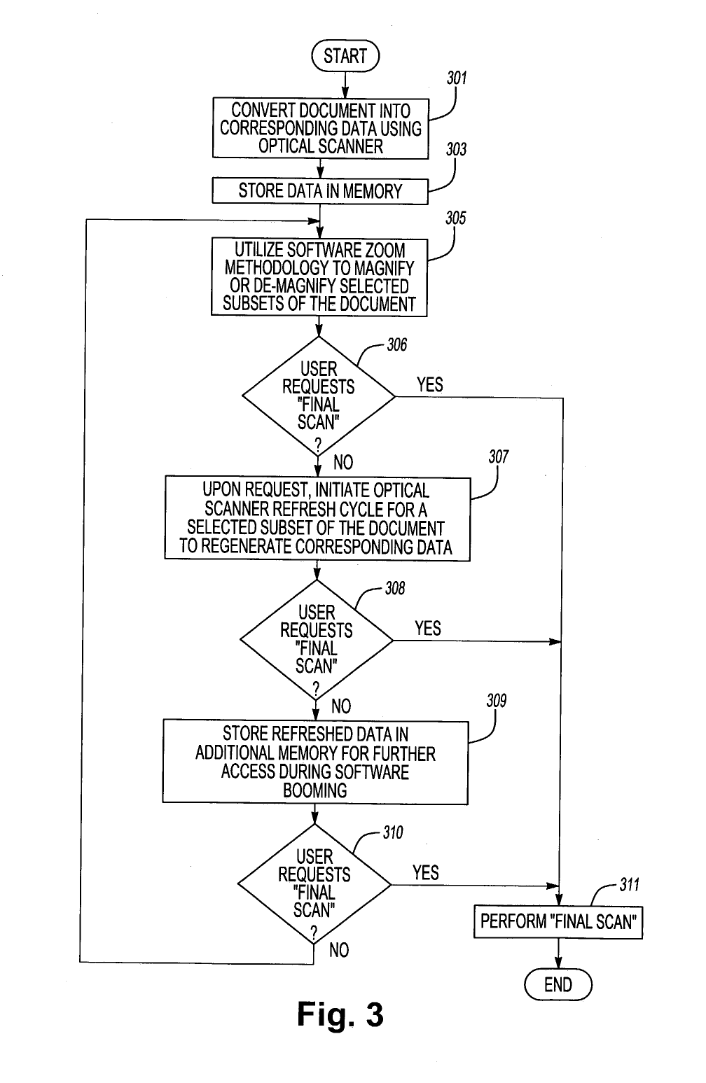

FIG. 3 summarizes a set of exemplary steps that can be taken by the microcontroller (“controller”) of the computer 3 in response to a set of computer-readable instructions configured to carry out the present invention. At step 301, the controller, using a scanner 7 (see FIG. 1), causes a document to be converted into a corresponding set of data. At 303, the controller causes the data corresponding to the document to be stored in a memory segment of the computer 3. At 305, the controller utilizes a software zoom methodology to allow a user to selectively magnify subsets of the document. At 306, the controller determines if the user has issued a command for a “final scan.” If so, then the controller causes a final scan to be initiated at block 311. If not, the controller, in response to a user request, initiates an optical refresh cycle (through the scanner 7) for a selected subset of the document to regenerate corresponding data, as shown at block 307. At 308, the controller again determines if the user has issued a command for a “final scan.” If so, then the controller causes a final scan to be initiated at block 311. If not, the controller causes the refreshed data to be stored in an additional memory segment for access during subsequent software zooming, as shown in block 309. At 310, the controller again determines if the user has issued a command for a “final scan.” If so, then the controller causes a final scan to be initiated at block 311. If not, then the steps are repeated starting at block 305. If the steps are repeated starting at block 305, the controller effectively allows the user to use the software zoom methodology to magnify further selected subsets of the documents, now relying upon refreshed data.

Further, though not illustrated in the flowchart of FIG. 3, the user may at any time choose to de-magnify (zoom out) a selected subset of the document, in which case the set of stored “refreshed” data capable of providing the highest resolution for the desired magnification level is used to generate the de-magnified image. When the user ultimately issues a “final scan” command, the controller causes the scanner to perform the “final scan” function, and, typically, the derived data is stored.

A benefit of the present invention is that it allows a user to zoom in on and zoom out from a scanned image relatively quickly using a software zoom technique, particularly when the clarity of the image is not of utmost importance. For instance, a user can generally use a relatively degraded image for purposes of identifying a desired portion of the image for a “final scan.” However, when the quality of the image becomes too degraded, or if the user desires a clearer image for any reason, the user can elect to re-scan that portion of the image in which the user is interested. In this way, the user has more control over the zoom process and can tailor the zooming process depending on whether the speed or clarity is most important.

What is claimed is:

1. A method of displaying a scanned image, comprising:
optically scanning a document to render an electronic image of said document;
displaying said electronic image;
zooming in on said image to magnify a subset of said electronic image using a software zooming methodology, thereby producing a first zoomed image; and
refreshing said first zoomed image by optically scanning a subset of said document corresponding to said first zoomed image.

2. The method of claim 1, wherein said refreshing step comprises obtaining data representative of said document subset.

3. The method of claim 2, further comprising zooming in on said refreshed first zoomed image to magnify a subset of said refreshed first zoomed image using a software zooming methodology, thereby rendering a second zoomed image from said refreshed first zoomed image.

4. The method of claim 3, wherein said step of zooming in on said refreshed first zoomed image comprises processing said data.

5. The method of claim 4, wherein said step of processing said stored data comprises scaling said stored data to render said second zoomed image.

6. The method of claim 3, further comprising the step of magnifying a subset of said second zoomed image using a software zooming methodology, thereby rendering a third zoomed image from said second zoomed image.

7. The method of claim 6 further comprising zooming out from said third zoomed image by deriving a zoomed-out image from said refreshed first zoomed image.

8. The method of claim 1, further comprising performing a final scan of said document subset.

9. The method of claim 8, wherein an elapsed time required to perform said final scan is greater than an elapsed time required to refresh said first zoomed image.

10. A method of displaying a scanned image, comprising the steps:
optically scanning a document to render an electronic image of said document;
displaying said electronic image;
repeatedly zooming in on said image to magnify a subset of said electronic image using a software zooming methodology, wherein each act of zooming in creates a corresponding zoom level;
selectively refreshing one or more zoom levels by optically scanning a subset of said document corresponding to said zoom level, wherein each act of refreshing creates a corresponding re-scan level; and
displaying a requested subset of said electronic image based upon a best re-scan level, which consists of one of said re-scan levels that results in a least degraded rendition of said requested subset of said electronic image.

11. A scanning system, comprising:
an optical scanner capable of deriving data representative of a visible image contained on a physical medium;
an electronic controller in communication with said scanner, said controller configured to process said data to render an electronic image from said data and further to magnify a subset of said electronic image using a software zooming methodology;
wherein said scanner is configured to:
derive refreshed data representative of a subset of said visible image corresponding to said electronic image subset; and
derive final data representative of said visible image subset.

12. The system of claim 11, wherein an elapsed time required to derive said final data is greater than an elapsed time required to derive said refreshed data.

13. The system of claim 11, wherein said final data corresponds to a resolution of said visible image subset that is higher than a resolution of said visible image subset corresponding to said refreshed data.

14. A scanning system, comprising:
means for deriving data representative of a visible image contained on a physical medium;
means for processing said data to render an electronic image from said data;
means for selectively magnifying a subset of said electronic image using a software zooming methodology; and
means for deriving a refreshed set of data representative of a subset of said visible image corresponding to said electronic image subset.

15. The scanning system of claim 14, further comprising means for deriving a final set of data from said visible image, wherein an elapsed time required to derive said final set of data is greater than an elapsed time required to derive said refreshed set of data.

16. The scanning system of claim 14, wherein said final set of data generates an electronic image having a higher resolution than an electronic image rendered from said refreshed set of data.

17. A computer-readable medium comprising instructions for:
converting a document into corresponding data using an optical scanner;
storing said data in a first memory segment;
utilizing a software zoom methodology to magnify selected subsets of said document; and
initiating an optical scanner refresh cycle for a selected subset of said document to regenerate data corresponding to said selected subset.

18. The computer-readable medium of claim 17, further comprising instructions for storing said refreshed data in a second memory segment.

19. The computer-readable medium of claim 18, further comprising instructions for utilizing said software zoom methodology to magnify selected subsets of the document based upon said refreshed data.

20. The computer-readable medium of claim 19, further comprising instructions for de-magnifying selected subsets of the document based upon said refreshed data stored in said second memory segment.

21. The computer-readable medium of claim 20, further comprising instructions for selectively performing a final scan of said document subset.
